(19) United States
(12) Patent Application Publication
(10) Pub. No.: US 2007/0124862 A1
(43) Pub. Date: Jun. 7, 2007

(54) Pillow with speakers

(76) Inventor: David J. Beyda, Brooklyn, NY (US)

Correspondence Address: AMSTER, ROTHSTEIN & EBENSTEIN LLP, 90 PARK AVENUE, NEW YORK, NY, 10016, US

(21) Appl. No.: 11/295,262

(22) Filed: Dec. 6, 2005

(51) Int. Cl. A61G 9/00

(52) U.S. Cl. 5/639; 5/904

(57) ABSTRACT

A pillow including an outer casing defining an inner chamber and fill material that at least partially fills the inner chamber to provide fluffiness to the pillow. A pocket is disposed on the outer casing for storage of a portable audio device. At least one speaker is disposed in the inner chamber that generates sounds based on audio signals emitted by the portable audio device.

### TECHNICAL FIELD

The present invention is generally related to sound delivery and transmission systems, and more particularly to speaker sound systems installed in pillows provided for use as a headrest.

### BACKGROUND

When resting on a pillow, a person often desires to listen to music or other sounds, such as, for example, white noise, for relaxation or to block out surrounding noise. Thus, pillows have been designed with internal speakers for the transmission of sounds through the pillow. Such pillows are useful where irritating ambient noises need to be masked so as not to interfere with sleep.

Prior art pillows having internal speakers require wiring that connect with external audio devices to provide electrical signals for the generation of sound waves through the speakers. However, these pillow designs have particular disadvantages. For example, when a user is laying in bed, the external audio devices may be spaced from the pillow on a night stand, so that the wires may get entangled around the user and/or in the bed sheets.

Accordingly, there is a need for a pillow with speakers having a compact design for storage of an associated audio device that still provides comfort to the user.

### SUMMARY OF THE INVENTION

A pillow according to an exemplary embodiment of the invention includes an outer casing defining an inner chamber and fill material that at least partially fills the inner chamber to provide fluffiness to the pillow. A pocket is disposed on the outer casing for storage of a portable audio device. At least one speaker is disposed in the inner chamber that generates sounds based on audio signals emitted by the portable audio device.

In at least one embodiment, an electrical cord that electrically connects the portable audio device to the at least one speaker is at least partially disposed within the inner chamber.

In at least one embodiment, the electrical cord is retractable onto a reel disposed within the inner chamber.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a perspective view of a pillow according to an exemplary embodiment of the invention;

FIG. 2 is a cross-sectional view of the pillow of FIG. 1;

FIG. 3 is a cross-sectional view of an electrical cord housing used with the pillow of FIG. 1;

FIG. 4 is a planar view of an end portion of the pillow of FIG. 1;

FIG. 5 is a perspective view of a pillow according to another exemplary embodiment of the invention; and

FIG. 6 is a perspective view of a pillow according to another exemplary embodiment of the invention.

### DETAILED DESCRIPTION OF PREFERRED EMBODIMENTS

The present invention is a pillow including at least one internal speaker that is electrically connected to a portable audio device stored in a pocket formed on the exterior of the pillow. This construction allows a user to enjoy music or other sounds generated from a portable audio device while the user is resting his head on the pillow.

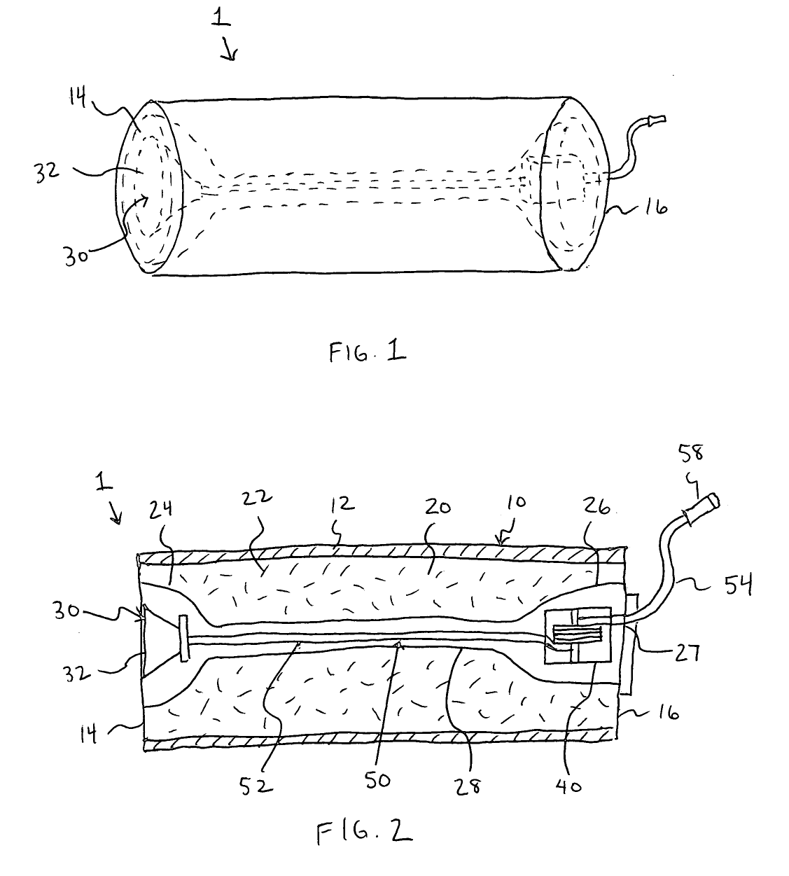

FIG. 1 shows a perspective view of the pillow, generally designated by the reference number 1, according to an exemplary embodiment of the invention, and FIG. 2 shows a cross sectional view of the pillow 1. It should be appreciated that, although the pillow 1 is shown as having a cylindrical profile, the pillow 1 may have any other suitable profile, such as a U-shaped profile or a more common rectangular profile. The pillow 1 includes an outer casing, generally designated by the reference number 10, having a main body portion 12, a first end portion 14 and a second end portion 16. The outer casing 10 may be made of any suitable stretchable or non-stretchable material, such as, for example, cotton, polyester, leather or fabric. The outer casing 10 defines an inner chamber 20, which is partially filled with a fill material 22 to provide the pillow 1 with shape and fluffiness. The fill material 22 may be, for example, poly-fil, cotton, down or foam, and may be in any suitable form, such as, for example, beads or pellets.

A first pouch 24 is disposed within the inner chamber 20 adjacent to the first end portion 14 of the pillow 1, a second pouch 26 is disposed within the inner chamber 20 adjacent to the second end portion 16 of the pillow 1 and a third pouch 28 is disposed between and in communication with the first and second pouches 24, 26. The pouches 24, 26 and 28 are made of any suitable material, and are preferably made of the same material as that of the outer casing 10. The first pouch 24 may be sewn on or otherwise attached to the inner surface of the first end portion 14, and the second pouch 26 may be sewn on or otherwise attached to the inner surface of the second end portion 16. As explained in further detail below, the pouches 24, 26 and 28 provide pockets within the inner chamber 20 that are not filled with the filler material 22.

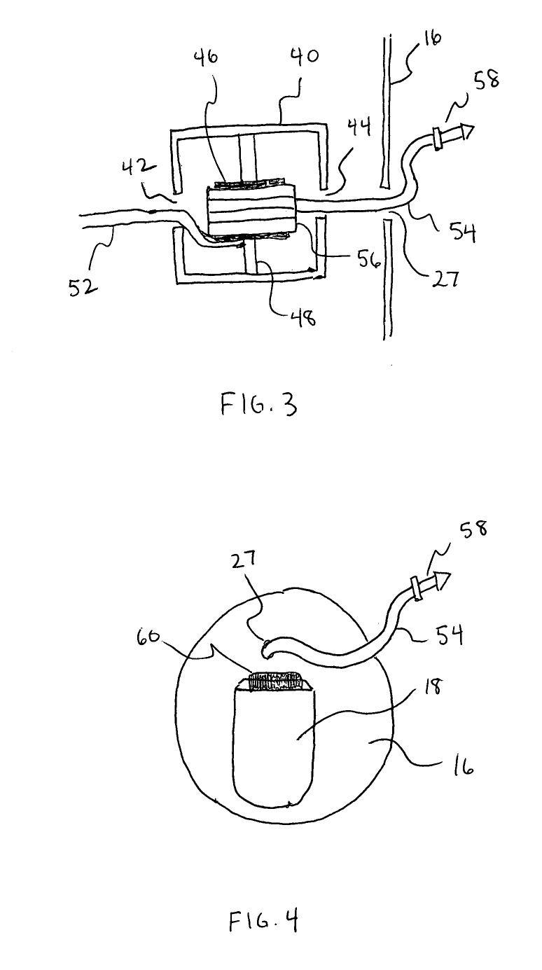

As shown in FIGS. 1 and 2, a speaker, generally designated by the reference number 30, is disposed within the first pouch 24. The speaker includes a sound-transmitting surface 32 preferably facing the inside surface of the first end portion 14 of the pillow 1. An electrical cord housing 40 is disposed within the second pouch 26. As shown in FIG. 3, the electrical cord housing 40 includes a first opening 42 facing the third pouch 28 and a second opening 44 facing the inner surface of the second end portion 16 of the pillow. A reel 46 is disposed within the electrical cord housing 40 and is mounted on a pin 48 for rotation.

The pillow 1 further includes an electrical cord, generally designated by the reference number 50. The electrical cord includes a first section 52 and a second section 54. The first section 52 is electrically connected to the speaker 30 and travels the length of the pillow through the third pouch 28 and into the second pouch 26. The second section 54 of the cord 50 is wound around the reel 46 to form a coil 56 and extends through the second opening 44 in the electrical cord housing 40. The second section 54 further extends through an opening 27 formed in the second end portion 16 of the pillow 1. The first section 52 of the cord 50 is preferably electrically connected to the coil 56 of the second section 54 of the cord 50 through the pin 48. As is well known in the art, the reel 46 may include a coil spring (not shown) for retracting and winding the second section 54 of the cord 50 around the reel 46 and/or a stop mechanism (not shown) to hold the extended position of the second section 54 of the cord 50. Examples of retractable cord and stop mechanisms are described in the following patents, all of which are incorporated herein by reference: U.S. Pat. No. 6,731,956; U.S. Pat. No. 6,088,021; U.S. Pat. No. 6,065,080; U.S. Pat. No. 6,019,304 and U.S. Pat. No. 5,094,396. The second section 54 of the cord 50 extends out of the opening 27 in the second end portion 16 of the pillow 1 and terminates in an electrical connector member, such as, for example, plug 58.

FIG. 4 is a planar view of the second end portion 16 of the pillow 1. A pocket 18 is disposed on the outer surface of the second end portion 16 for storage of a portable audio device 60, such as, for example, an MP-3 player. The plug 58 of the second section 54 of the cord 50 connects to the portable audio device 60 to power and play music through the speaker 30.

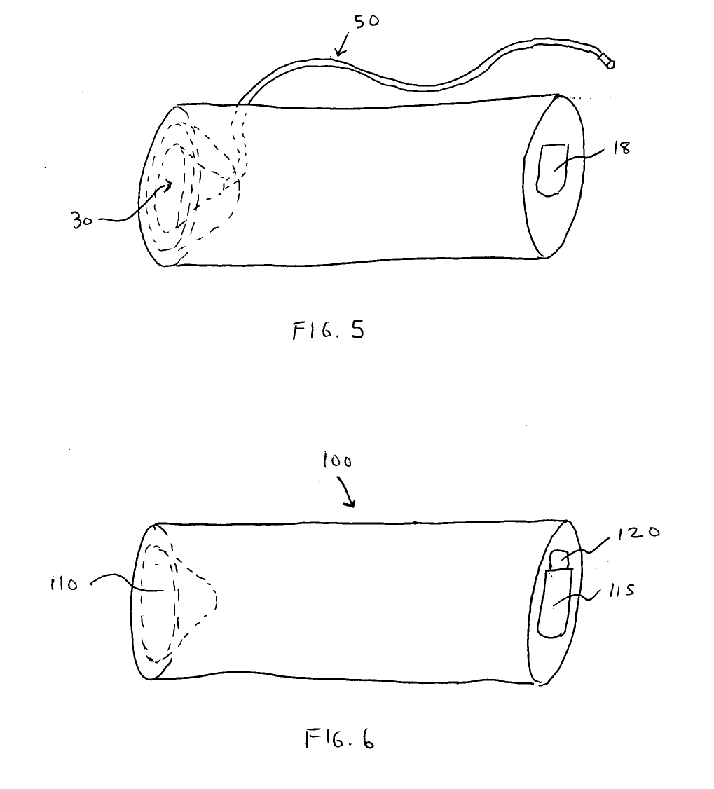

Although three pouches are used in the previous embodiment, it should be appreciated that the present invention is not limited to such construction. For example, as shown in FIG. 5, the electrical cord 50 may extend outside the pillow casing 10 from the speaker 30, so that the third pouch 28 is not required. Also, the location of the pocket 18 is not limited to the second end portion 16, and may be located at any portion of the outer surface of the casing 10. For example, the pocket 18 may be located adjacent to the speaker 30 at the first end portion 14 of the casing 10, or may be located along the main body portion 12 so that the third pouch 28 that houses the electrical cord 50 does not need to extend the entire length of the pillow. In still further embodiments, the pillow may be constructed without pouches, so that the speaker, electrical cord and/or the electrical cord housing are simply housed within the inner chamber 20. The speaker 30 may be located at any location within the inner chamber 20.

The pillow of the present invention may also be used with a wireless sound emitting system, in which case the pillow may be constructed without the electrical cord and associated pouch and electrical cord housing. For example, FIG. 6 shows a pillow according to an embodiment of the invention, generally designated by the reference number 100, including only a speaker 110 and a pocket 115 for storage of a wireless audio signal emitting device 120.

Now that the preferred embodiments have been shown and described in detail, various modifications and improvements thereon will be readily apparent to those skilled in the art. Accordingly, the spirit and scope of the present invention is to be construed broadly and be limited only by the appended claims, and not by the foregoing specification.

What is claimed is:

1. A pillow comprising:
an outer casing defining an inner chamber;
fill material that at least partially fills the inner chamber to provide fluffiness to the pillow;
a pocket disposed on the outer casing for storage of a portable audio device; and
at least one speaker disposed in the inner chamber that generates sounds based on audio signals emitted by the portable audio device.

2. The pillow of claim 1, further comprising an electrical cord at least partially disposed within the inner chamber that electrically connects the portable audio device to the at least one speaker.

3. The pillow of claim 1, wherein the electrical cord is retractable.

4. The pillow of claim 3, wherein the electrical cord is retractable onto a reel, and the reel is disposed within the inner chamber.

5. The pillow of claim 4, further comprising a first pouch disposed in the inner chamber for storage of the reel.

6. The pillow of claim 5, further comprising a second pouch disposed in the inner chamber for storage of the at least one speaker.

7. The pillow of claim 6, further comprising a third pouch in communication with both the first and second pouches for storage of a portion of the electrical cord that extends from the at least one speaker to the reel.

8. The pillow of claim 4, wherein the outer casing defines an elongated shape having a first end and a second end opposite the first end, and the at least one speaker is disposed at the first end and the reel is disposed at the second end.

9. The pillow of claim 8, wherein the pocket is disposed on the second end of the outer casing.

10. The pillow of claim 9, further comprising an opening in the second end that allows the electrical cord to extend through the outer casing and connect to the portable audio device.

11. The pillow of claim 1, wherein the portable audio device is a wireless device.

12. The pillow of claim 1, wherein the outer casing defines a cylindrical profile.

13. The pillow of claim 1, wherein the outer casing defines a U-shaped profile.

14. The pillow of claim 1, wherein the outer casing defines a rectangular profile.
